(19) United States
(12) Patent Application Publication
(10) Pub. No.: US 2010/0281986 A1
(43) Pub. Date: Nov. 11, 2010

(54) MULTIPOINT LASER DOPPLER VIBROMETER

(76) Inventors: Vincent Toal, Dublin (IE); Maurice Whelan, Angera (IT); Michael Connelly, Tipperary (IE); Suzanne Martin, Dublin (IE); Tulasi Sridhar Reddy Guntaka, Dublin (IE)

Correspondence Address: JACOBSON HOLMAN PLLC, 400 SEVENTH STREET N.W., SUITE 600, WASHINGTON, DC, 20004, US

(21) Appl. No.: 12/733,971

(22) PCT Filed: Oct. 2, 2008
(86) PCT No.: PCT/IE2008/000095

§ 371 Date: Jul. 12, 2010

(30) Foreign Application Priority Data
Oct. 3, 2007 (IE) 2007/0706

(51) Int. Cl. G01H 9/00

(52) U.S. Cl. 73/656

(57) ABSTRACT

A multipoint laser Doppler vibrometer system (1) comprises a laser diode (2), beam expanding lens (3), a holographic optical element (HOE, 4) and a CMOS camera (5) receiving reflected light via optics (6). The HOE (4) is a hologram of a flat diffusely reflecting surface. Some light (8) is diffracted by the recorded hologram in the HOE (4) to provide a reference beam of light that is directed back towards the camera (5). Apart from some absorption the remaining light (9) continues onwards to illuminate the object The light that is reflected and scattered from the object (10) passes efficiently through the HOE (4) and interferes with the reference light (8) that is holographically reconstructed by the HOE (4) and subsequently detected by the camera (5). The beam from the laser diode (2) is divergent, which means that the sensitivity vector varies across the field of view. Thus the system is sensitive to both in-plane and out-of-plane motion of the object to an extent that depends on position of the object points. An alternative system (20) has two emission lenses (22, 23). The HOE (21) either redirects light already collimated by the lens combination (22, 23) or both redirects and collimates uncollimated light in such a way as to illuminate the object along the normal to its surface.

### FIELD OF THE APPLICATION

The present application relates generally to the measurement of vibration.

### PRIOR ART DISCUSSION

Laser Doppler vibrometry (“LDV”) is used in a wide variety of applications. Among these are the study of body and other panels and rotating parts (bearings, turbine blades) in air, sea and land transport vehicles as well as the evaluation of tyre, exhaust and brake pad noise. Civil engineering structures such as buildings, bridges, power station cooling towers, wind electricity generators, communications antennae and large storage vessels are routinely examined as part of the predictive maintenance schedule. Household appliances including loudspeakers, furniture and sound absorption materials are also tested. Disk drives, circuit boards, microelectromechanical components and micromachines are also studied. Other application areas are in the health and environmental sciences as well as food and food packaging quality assessment.

Laser Doppler vibrometers work on the general principle of interferometry. Light from a laser is reflected from the vibrating object and its frequency is Doppler shifted to an extent determined by the instantaneous velocity of the object. The light is mixed with the transmitted light at a photoelectric detector to produce an electrical signal whose frequency is determined by the Doppler shift. In simple form the system cannot distinguish between movement toward or away from the laser source but if the light from the laser is initially frequency modulated to produce an optical carrier frequency, the frequency spectrum of the Doppler shifted light is centred around the modulation frequency. A detected signal frequency less than the modulation frequency indicates that the object is receding while a frequency higher than the modulation frequency indicates that the object is approaching the source.

With such a carrier-based approach one can implement either pure heterodyning, in which acousto-optic frequency shifters generate the optical carrier (see Drain L. E. and Moss B. C. “The frequency shifting of laser light by electro optic techniques, Opto-electronics 4, 429, 1972, Durao D. F. G. and Whitelaw J. H. “The performance of acousto-optic cells for laser Doppler anemometry”, J. Phys E: Scientific Instruments, 776-80, 1975), or synthetic heterodyning where we vary the drive current of the laser diode to modulate its wavelength (see Connelly M. J. “Digital synthetic-heterodyne interferometric demodulation” Journal of Optics A: Pure and Applied Optics, 4, 400-405, 2002). The signal from the photodetector must be demodulated, using either analog or digital processing, in order to extract the Doppler shifted signal, and hence the velocity.

Another approach has been self-mixing in the laser (M. J. Rudd “Laser Doppler velocimeter employing the laser as a mixer-oscillator” J. Phys. E. 1, 723-6, 1968). The reflected light from the object re-enters the laser cavity so that the output from the laser is amplitude modulated at the Doppler frequency. A monitor photodiode is used to detect the beat signal, which is further processed to extract the required information. Direction of motion may also be obtained (E. T. Shimizu “Directional discrimination in the self-mixing type laser Doppler velocimeter” Appl. Opt. 26, 4541-4, 1987) although heterodyning is still used as in U.S. Pat. No. 5,838,439.

Many LDV systems are single point, meaning that the laser beam is directed to a point on the object and the vibration characteristic at that point is analysed. Other object points can be likewise examined simply by redirecting the laser and an imaging system may be incorporated as described in JP2003149041. An alternative approach is to cause the laser to scan rapidly over the object surface as described in DE3113090, in which a raster scan of the object region is performed by means of a mirror which can be swivelled in steps, about two mutually perpendicular axes. Here, an image of the object obtained by means of a television camera is presented along with a spatial image of the object vibrations. It is important that the direction (directional cosines) of the illuminating beam always be accurately specified to the system software so that the direction of motion can be reliably determined from the illumination and observation geometry. This requires that the optical system for steering the laser beam be precisely controlled and monitored as described in JP2002221077, and significantly increases the system cost.

Multipoint systems are preferred as very few objects vibrate in a simple harmonic fashion. Complex modal or simultaneous multimodal behaviour is commonly encountered and so, in order to fully characterise a vibration state, it is necessary to probe more than one point at the same time. For example in US2006055937, a beam of coherent light is split into an object beam and a reference beam. The object beam is then divided into a number of object beams to simultaneously illuminate multiple locations on the object under inspection. The reference beam is frequency shifted and split into a corresponding number of frequency-shifted reference beams. A portion of each object beam is reflected by the object as a modulated object beam. The object beams are collected and respectively mixed, each with a frequency-shifted reference beam, to provide a number of beam pairs. Each pair is focused onto a photodetector or an optical fiber connected to a photodetector.

Multipoint sensitivity may alternatively be obtained by using a complementary metal oxide silicon (CMOS) camera with an on-board digital signal processor (DSP), (see Aguanno M. V., Lakestani F, Whelan M. P. and Connelly M. J., “Single-pixel carrier based approach for full-field laser interferometry using a CMOS-DSP camera”, in Proc. Optical Systems Design Conference, St. Etienne, France, pp 67-76, 2003).

A further approach is presented in DE19859781A1 in which a reference beam is provided by a transmission holographic optical element in such a way as to ensure that the system is sensitive to purely out-of-plane motion or to purely-in-plane motion depending on the geometry that is chosen. The system described is in fact an electronic speckle pattern interferometer rather than a laser Doppler vibrometer. The basic optical interferometric principle still applies but the whole field image is electronically filtered and time averaged by means of the persistence time of the video camera to provide images overlaid with Bessel function modulated fringe patterns, which are contours of constant displacement.

The invention is directed towards providing an improved vibration measurement system.

### STATEMENTS OF INVENTION

According to the invention, there is provided a vibration measurement system comprising:
a laser light source having means for generating a laser beam and for modulating its wavelength according to a laser Doppler vibrometer scheme;
a camera for receiving scattered light from an object,
an image processor for demodulating light detected by the camera according to the laser Doppler vibrometer scheme to determine vibration of the object; and
optics to direct light from the light source to illuminate the object, and to provide a reference beam for the camera, in which a holographic optical element is used in providing the reference beam.

In one embodiment, the optics include a reflective holographic optical element for providing both the reference beam and an object illuminating beam.

In another embodiment, the optics further comprise a transmissive holographic optical element to re-direct a beam of light so that the object is illuminated along a direction substantially normal to its surface.

In a further embodiment, the transmissive holographic optical element also collimates light.

In one embodiment, the optics comprise a transmissive holographic optical element arranged to diffract light to produce a diffuse beam of light to act as a reference beam.

In another embodiment, the optics further comprise a partially reflective plane mirror to direct a parallel or collimated beam of light so as to illuminate the object along an axis substantially normal to its surface.

In a further embodiment, the optics further comprise a reflective holographic optical element to diffract a parallel or collimated or diverging beam of light so as to produce a collimated beam of light to illuminate the object substantially normal to its surface.

In one embodiment, a holographic optical element comprises means for providing, from an incident collimated beam, both a reference beam and an object illuminating beam and further directs the object beam substantially normal to the object surface.

In another embodiment, the optics are adapted to illuminate the object substantially normal to its surface and the camera is arranged whereby the scattered light travels generally along an optical axis of the camera, whereby the system is sensitive only to out-of-plane vibration.

In a further embodiment, the reflective holographic optical element is of silver halide material.

In one embodiment, the transmissive holographic optical element is of photopolymer material.

In another embodiment, the holographic optical element is a diffractive grating which is sensitive to in-plane vibration.

In a further embodiment, the grating is of the type which is produced holographically.

In one embodiment, the reflective holographic optical element is recorded at one wavelength and is used at another wavelength with appropriate angular adjustments.

In another embodiment, the camera is a Complementary Metal Oxide Silicon (CMOS) camera.

In a further embodiment, the CMOS camera provides random individual pixel access.

In one embodiment, the diffraction efficiencies of each holographic optical element is chosen so that the object and reference beams at the camera are of equal intensity.

In another embodiment, the image processor is incorporated in the camera.

In a further embodiment, the light source comprises a semiconductor laser diode, and the modulation is performed by controlling the drive current.

In one embodiment, the image processor is adapted to perform synthetic heterodyning to extract a vibration signal.

In another embodiment, the light source comprises a distributed feedback laser.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a diagram illustrating a vibration measurement system of the invention;

FIG. 2 is a diagram of an alternative vibration measurement system;

FIG. 3 is a diagram of a further alternative vibration measurement system:

FIG. 4 is a diagram a further vibration measurement system:

FIG. 5 is a display of a 2.22 kHz interferometer signal (upper trace) and drive signal (lower trace); and

FIG. 6 shows a typical screen display of a retrieved vibration spectrum.

### DESCRIPTION OF THE EMBODIMENTS

Vibration measurement systems of the invention in some embodiments include:
illumination by a light source which performs wavelength modulation of the emitted light according to an LDV scheme;
a camera for receiving light from the object being monitored and a reference beam;
optics including a holographic optical element to direct a reference beam to the optical detector and to illuminate the object with a collimated beam of light and to allow the object to be normally imaged by a lens,
single pixel processing of the light detected by the camera to determine the vibration characteristics at any chosen point on the object surface and at more than one point at the same time.

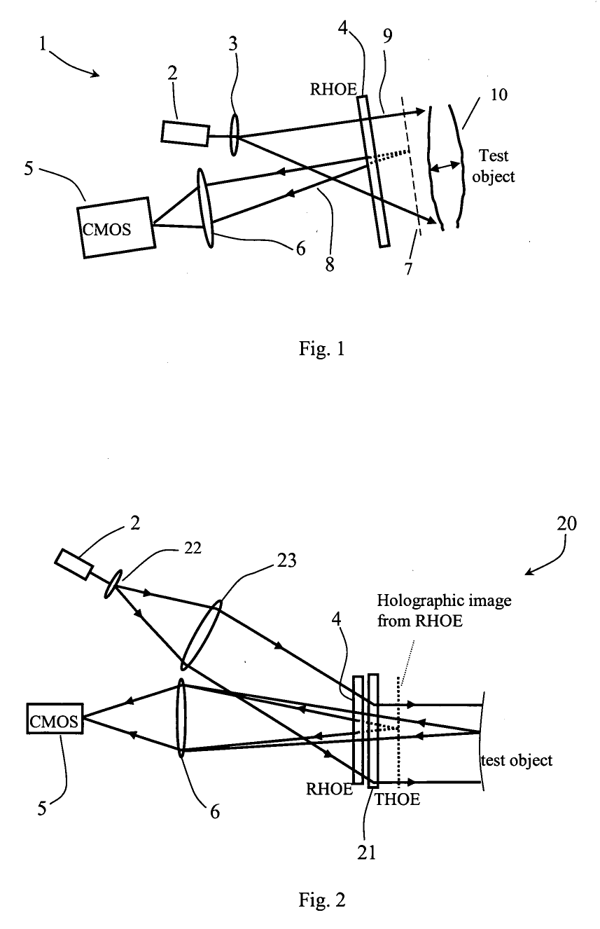

The use of a holographic optical element in an electronic speckle pattern interferometer was presented in Guntaka, S. R., Toal, V., Martin, S., “Holographically recorded diffractive optical elements for holographic and electronic speckle pattern interferometry”, Applied Optics, 41, 7475-7479, 2002. In the present invention such a reflective HOE is used in the embodiment of FIG. 1.

Referring to FIG. 1 a system 1 comprises a laser diode 2, beam expanding lens 3, a holographic optical element (HOE) 4 and a CMOS camera 5 receiving reflected light via optics 6. The HOE 4 is a hologram of a flat diffusely reflecting surface whose holographically reconstructed (in this case virtual) image, 7, is also shown in FIG. 1. The HOE 4 is fabricated in silver halide, or in other embodiments it may be in a photopolymer using the Denysiuk method. Some light, 8, is diffracted by the recorded hologram in the HOE 4 to provide a reference beam of light that is directed back towards the camera 5. Apart from some absorption the remaining light, 9, continues onwards to illuminate the object The light that is reflected and scattered from the object, 10, being, now generally off-Bragg, passes efficiently through the HOE 4 and interferes with the reference light, 8, that is holographically reconstructed by the HOE 4 and subsequently detected by the camera 5. The beam from the laser diode 2 is divergent, which means that the sensitivity vector varies across the field of view. Thus the system is sensitive to both in-plane and out-of-plane motion of the object to an extent that depends on position of the object points.

Referring to FIG. 2, in an alternative system 20, to overcome this difficulty a second transmissive HOE, 21, may be introduced. Like parts are assigned the same reference numerals. The system 20 has two emission lenses 22 and 23. The HOE 21 either redirects light already collimated by the lens combination 22 and 23 or both redirects and collimates uncollimated light in such a way as to illuminate the object along the normal to its surface.

The functions of both the reflection and transmission HOEs 4 and 21 may alternatively be combined in a single element which will provide both the reference beam and the object illuminating beam. However an advantage of using separate HOEs is that they may be employed to optimise the relative intensities of the object and reference beams by rotation of each of the elements separately about their principal axes.

The optical axis of the CMOS camera 5 is also parallel to the normal to the object so that the illumination and observation directions are both normal to the object. Thus the system is sensitive only to purely out-of-plane motion of the object.

The camera 5 features random region of interest pixel access in space and time at fast frame rates. In this way multipoint LDV can be implemented as each pixel corresponds to a single point on the object.

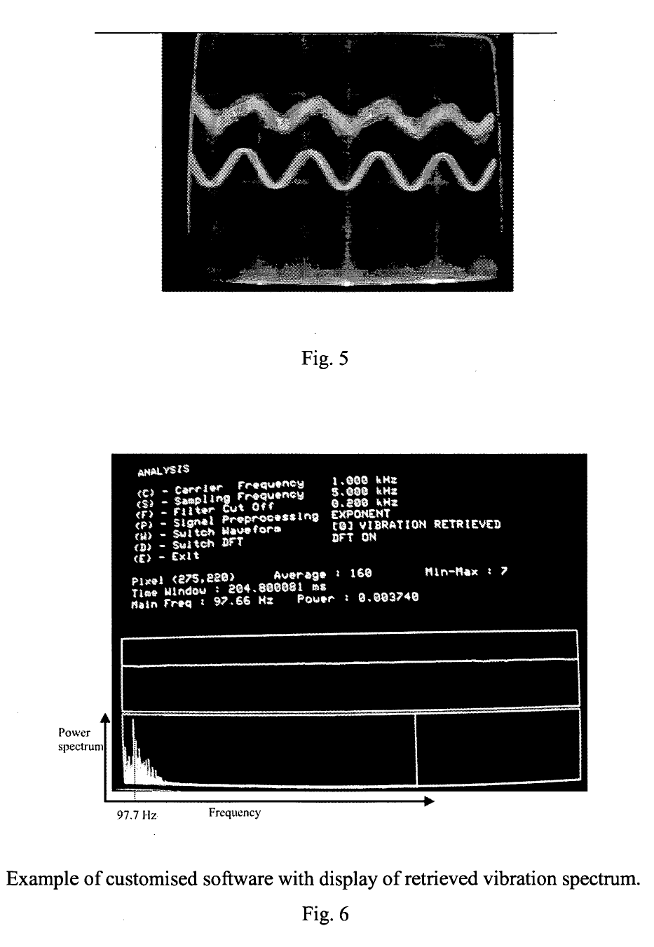

In more detail, the laser light is spatially filtered and collimated and illuminates the RHOE (reflective HOE) 4 and the THOE (transmissive HOE) 21. The RHOE 4 reconstructs the beam of light originally scattered from a diffusely reflecting surface, to act as a reference beam. The RHOE 4 efficiency of 50% allows the transmission of the remaining incident light, 85% of which is diffracted into the first order by the THOE 21. The object under test is a metal disc mounted on a piezoelectric transducer driven by a sinusoidal varying voltage. The reflected light from the object is efficiently transmitted through the two HOEs, being now off-Bragg, and interferes with the reference beam at the CMOS camera 5. To evaluate the quality of the signal from the interferometer, a lens with an adjustable iris diaphragm was used to image the object onto a pinhole of diameter 25 μm placed in front of a photomultiplier tube (PMT type IP28A), not shown. A typical result is shown in FIG. 5. The modulation depth was 25% but this figure is not optimal as the lens aperture needed to be quite large in order to obtain a signal so that the speckle size was not matched to the aperture of the PMT. The light from the interferometer was detected by the CMOS camera for processing to retrieve the vibration signal.

The sensitivity of an interferometer-based displacement/vibration detection system is dependent on the ambient conditions. If the refractive index of the interferometer cavity changes due to slowly varying ambient conditions, such as temperature, then the sensitivity will drift. The sensitivity is a maximum when the interferometer is in quadrature and a minimum when it is out of quadrature. This problem can be overcome through the use of synthetic heterodyne demodulation. This technique involves the synthesis of a heterodyne signal from an induced phase modulation. The phase modulation can be generated through suitable sinusoidal modulation of the laser frequency. In the case of a diode laser, this can be achieved by small-signal modulation of the laser current. The modulation frequency is chosen such that it is much larger than the frequency of the vibration signal of interest. The resulting synthetic heterodyne signal will contain harmonics at integer multiples of the laser modulation frequency. The sidebands of the harmonics contain the vibration signal of interest. The first two harmonics and associated sidebands can be combined by a process of differentiation and cross-multiplication to obtain an output signal proportional to the original vibration signal, which is not affected by interferometer drift. In the experiment, the 650 nm laser diode current was sinusoidally modulated at 1 kHz. The synthetic heterodyne technique was implemented in real-time on the camera DSP. The camera was interfaced to a computer with customised software for subsequent analysis and display of the retrieved vibration signal. The camera 5 was focused on to the object to obtain a sharp image which was displayed on a computer monitor. Individual camera pixels with good amplitude modulation were selected and analysed. An example of the power spectrum of a successfully retrieved vibration signal is shown in FIG. 6. Vibration frequencies of up to 100 Hz were successfully retrieved. Some instability was experienced because the side-mode rejection ratio of the Fabry-Perot laser was only approximately 7 dB. In addition, although the laser temperature was carefully controlled, the laser was still prone to mode-hopping. A much improved performance would be expected from a single-wavelength laser such as a distributed feedback laser.

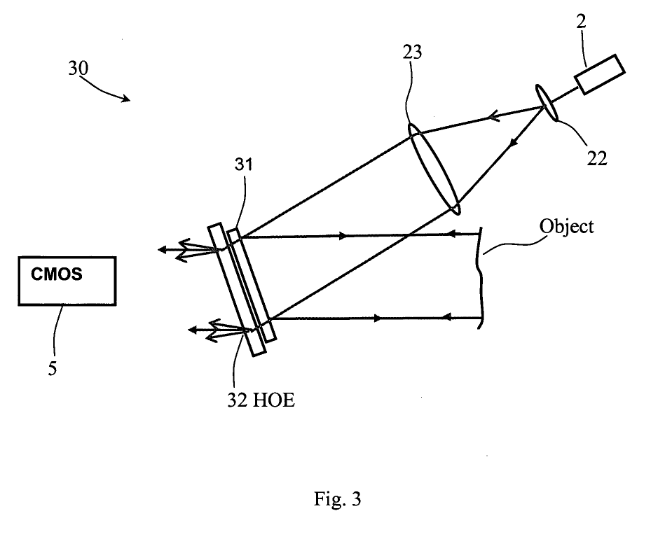

Referring to FIG. 3, in an alternative system 30 the laser light illuminates a partial mirror 31 and some light is reflected directly onto the vibrating object. The remainder is diffracted by a diffusely transmissive holographic diffraction grating, 32, to produce a diffuse beam of light acting as a reference beam and directed along the optical axis of the CMOS camera 5. In another embodiment the partial mirror 31 can be replaced by a reflective holographic diffraction grating. In another embodiment the reflective holographic diffraction grating and the diffusely transmissive holographic diffraction grating may be recorded in a single photosensitive layer, either of silver halide or of a photopolymer.

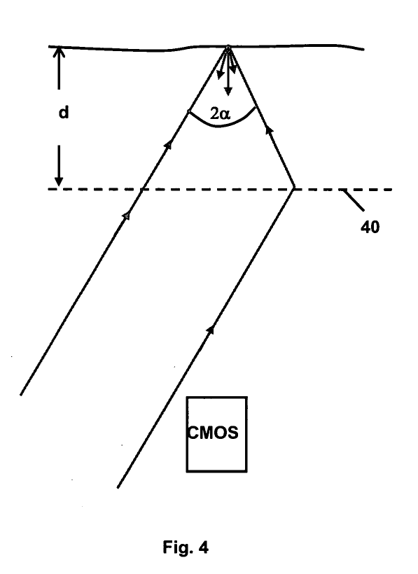

In a further embodiment, shown in FIG. 4, a system is sensitive only to in-plane motion of the object. Here, a holographic diffraction grating 40 of about 50% diffraction efficiency is used, and the phase difference between two light rays illuminating the same point on the object is Δφ, given by

Δφ=−4πd sin² α/(λ cos α)

where d is the distance between the grating and the object planes, λ is the wavelength of the laser light and 2α is the angle between the two illuminating beams used in recording the holographic grating.

It can be seen that modulation of the wavelength of the laser by altering the current enables the phase difference between the beams of light in this interferometer to be altered in a manner similar to that in the out-of-plane sensitive system. Local variations in the value of d due to out-of-plane movement of the object or due to surface height variations of the object will produce changes in Δφ. This means that the system is sensitive to out-of plane motion of the object The phase shift introduced by a local in plane displacement, D, is given by:

Δφ′=4πD sin α/λ

Thus the system is also sensitive to in-plane motion as well. Using a combination of a purely out-of-plane sensitive system as already described (FIG. 2 or 3) and a system such as this that is sensitive to both out-of-plane and in-plane motion, one can extract the in-plane component of motion using image processing.

It will be appreciated that the invention provides a simple out-of-plane multipoint LDV system incorporating HOEs and a CMOS DSP camera, able to detect vibration signals at frequencies up to 100 Hz from a vibrating surface. The CMOS DSP camera allows for random pixel access thereby enabling the user to examine particular regions of interest on the vibrating surface.

The invention is not limited to the embodiments described but may be varied in construction and detail.

1-23. (canceled)

24. A vibration measurement system comprising:
a laser light source having means for generating a laser beam and for modulating its wavelength according to a laser Doppler vibrometer scheme;
a camera for receiving scattered light from an object,
an image processor for demodulating light detected by the camera according to the laser Doppler vibrometer scheme to determine vibration of the object; and
optics to direct light from the light source to illuminate the object, and to provide a reference beam for the camera, in which a holographic optical element is used in providing the reference beam.

25. The vibration measurement system as claimed in claim 24, wherein the optics include a reflective holographic optical element for providing both the reference beam and an object illuminating beam.

26. The vibration measurement system as claimed in claim 24, wherein:
the optics include a reflective holographic optical element for providing both the reference beam and an object illuminating beam; and
wherein the optics further comprise a transmissive holographic optical element to re-direct a beam of light so that the object is illuminated along a direction substantially normal to its surface.

27. The vibration measurement system as claimed in claim 24, wherein:
the optics include a reflective holographic optical element for providing both the reference beam and an object illuminating beam; and
wherein the optics further comprise a transmissive holographic optical element to re-direct a beam of light so that the object is illuminated along a direction substantially normal to its surface; and wherein the transmissive holographic optical element also collimates light.

28. The vibration measurement system as claimed in claim 24, wherein the optics comprise a transmissive holographic optical element arranged to diffract light to produce a diffuse beam of light to act as a reference beam.

29. The vibration measurement system as claimed in claim 24, wherein:
the optics comprise a transmissive holographic optical element arranged to diffract light to produce a diffuse beam of light to act as a reference beam; and
wherein the optics further comprise a partially reflective plane mirror to direct a parallel or collimated beam of light so as to illuminate the object along an axis substantially normal to its surface.

30. The vibration measurement system as claimed in claim 24, wherein:
the optics comprise a transmissive holographic optical element arranged to diffract light to produce a diffuse beam of light to act as a reference beam; and
wherein the optics further comprise a reflective holographic optical element to diffract a parallel or collimated or diverging beam of light so as to produce a collimated beam of light to illuminate the object substantially normal to its surface.

31. The vibration measurement system as claimed in claim 24, wherein:
the optics include a reflective holographic optical element for providing both the reference beam and an object illuminating beam; and
wherein the optics further comprise a transmissive holographic optical element to re-direct a beam of light so that the object is illuminated along a direction substantially normal to its surface; and
wherein the transmissive holographic optical element also collimates light; and
wherein a holographic optical element comprises means for providing, from an incident collimated beam, both a reference beam and an object illuminating beam and further directs the object beam substantially normal to the object surface.

32. The vibration measurement system as claimed in claim 24, wherein the optics are adapted to illuminate the object substantially normal to its surface and the camera is arranged whereby the scattered light travels generally along an optical axis of the camera, whereby the system is sensitive only to out-of-plane vibration.

33. The vibration measurement system as claimed in claim 24, wherein the optics include a reflective holographic optical element for providing both the reference beam and an object illuminating beam; and wherein the reflective holographic optical element is of silver halide material.

34. The vibration measurement system as claimed in claim 24, wherein the optics include a reflective holographic optical element for providing both the reference beam and an object illuminating beam; and wherein the optics further comprise a transmissive holographic optical element to re-direct a beam of light so that the object is illuminated along a direction substantially normal to its surface; and wherein the transmissive holographic optical element is of photopolymer material.

35. The vibration measurement system as claimed in claim 24, wherein the holographic optical element is a diffractive grating which is sensitive to in-plane vibration.

36. The vibration measurement system as claimed in claim 24, wherein the holographic optical element is a diffractive grating which is sensitive to in-plane vibration; and wherein the grating is of the type which is produced holographically.

37. The vibration measurement system as claimed in claim 24, wherein the optics include a reflective holographic optical element for providing both the reference beam and an object illuminating beam; and wherein the reflective holographic optical element is recorded at one wavelength and is used at another wavelength with appropriate angular adjustments.

38. The vibration measurement system as claimed in claim 24, wherein the camera is a Complementary Metal Oxide Silicon (CMOS) camera.

39. The vibration measurement system as claimed in claim 24, wherein the camera is a Complementary Metal Oxide Silicon (CMOS) camera; and wherein the CMOS camera provides random individual pixel access.

40. The vibration measurement system as claimed in claim 24, wherein the diffraction efficiency of each holographic optical element is chosen so that the object and reference beams at the camera are of equal intensity.

41. The vibration measurement system as claimed in claim 24, wherein the image processor is incorporated in the camera.

42. The vibration measurement system as claimed in claim 24, wherein the light source comprises a semiconductor laser diode, and the modulation is performed by controlling the drive current.

43. The vibration measurement system as claimed in claim 24, wherein the image processor is adapted to perform synthetic heterodyning to extract a vibration signal.

44. The vibration measurement system as claimed in claim 24, wherein the light source comprises a distributed feedback laser.
